(19) United States
(12) Patent Application Publication
(10) Pub. No.: US 2004/0080313 A1
(43) Pub. Date: Apr. 29, 2004

(54) Modular non-contacting position sensor

(76) Inventor: Amnon Brosh, Santa Monica, CA (US)

Correspondence Address: DUANE MORRIS LLP, Suite 100, 100 College Road West, Princeton, NJ, 08540, US

(21) Appl. No.: 10/264,292

(22) Filed: Oct. 3, 2002

Related U.S. Application Data
(60) Provisional application No. 60/326,891, filed on Oct. 3, 2001.

(51) Int. Cl. G01B 7/14; H01F 5/00; H01F 7/06; G08C 19/06

(52) U.S. Cl. 324/207.18; 324/207.17; 340/870.36; 29/602.1; 29/605; 29/606

(57) ABSTRACT

A method for forming a non-contact position sensor having a predetermined stroke length comprises providing a pair of coil assemblies each comprising a primary and secondary coil of a predetermined size; providing a core member of varying magnetic density about its length; and inserting the core member within the coil assemblies, whereby axial movement of the core member relative to the coil assemblies causes a corresponding output signal from the coil assemblies indicative of the position of the core member.

### CROSS REFERENCE TO RELATED APPLICATIONS

This application claims priority from co-pending Provisional Patent Application Serial No. 60/326,891 entitled “Modular Non-Contacting Position Sensor”, filed on Oct. 3, 2001.

### FIELD OF THE INVENTION

The invention relates generally to sensor systems, and more particularly to electromechanical transducers for producing an output signal proportional to displacement of a moveable member.

### BACKGROUND OF THE INVENTION

Linear variable position transformers such as LVDTs, variable reluctance devices (VRs) and other similar position sensors normally consist of a coil assembly, a ferromagnetic core or conductive spoiler and a housing. The coil assembly includes a number of coils that are wound on a bobbin or coil form whose shape and length are designed to accommodate a measured movement or stroke. Presently, LVDTs are manufactured in various shapes and sizes based on the stroke length desired for a particular application. Such varying stroke lengths, however, in the present state of the art, require many different coil assemblies to be designed, built and stored. This is a significant drawback for both manufacturing and maintaining such devices. In addition, position sensor units designed to meet unique customer applications also require new or non-standard coil assemblies. This exacerbates the above-described problems since LVDT coil forms are relatively complex, multi-sectional bobbins which generally increase in complexity with the increase in stroke length. Accordingly, the cost of manufacturing the coil forms, in addition to the cost of winding and interconnecting the coils, is a significant factor in the price of such position sensors.

Therefore, a need in the art exists for a position sensor that overcomes the above-described drawbacks and a process for making such a sensor.

### SUMMARY OF THE INVENTION

A method for forming a non-contact position sensor having a predetermined stroke length comprises providing a pair of coil assemblies each comprising a primary and secondary coil of a predetermined size; providing a core member of varying magnetic density about its length; and inserting the core member within the coil assemblies, whereby axial movement of the core member relative to the coil assemblies causes a corresponding output signal from the coil assemblies indicative of the position of the core member.

A non-contact position sensor having a predetermined stroke length comprises a core member; and a pair of modular coil assemblies disposed about the core member, the pair of modular coil assemblies being of predetermined dimensions, wherein the core member has a magnetic density that varies along its length such that axial movement of the core induces corresponding signals in the pair of modular coil assemblies indicative of the position of the core.

A method of forming a non-contacting position sensor having a predetermined stroke length comprising providing a first standard coil of predetermined size; providing a second standard coil of the same predetermined size; providing a core member; pre-spoiling the first standard coil to be insensitive to movement of the core member about the first coil; varying the magnetic density of the core member about its length in accordance with the predetermined stroke length and the size of the first and second standard coil assembly; and inserting the core member within the first and second standard coils, whereby axial movement of the core member relative thereto causes a corresponding output signal from the first and second coils indicative of the position of the core member.

### BRIEF DESCRIPTION OF THE DRAWINGS

In the drawings:

FIG. 1A is an exemplary diagram of a Prior Art LVDT device useful for applications requiring short stroke lengths.

FIG. 1B is an exemplary diagram of a Prior Art long stroke LVDT device.

FIG. 1C illustrates an exemplary circuit diagram corresponding to the prior art position sensor shown in FIG. 1B.

FIG. 1D is an exemplary diagram of a Prior Art variable reluctance (VR) position sensor.

FIG. 1E illustrates an exemplary circuit diagram corresponding to the prior art position sensor shown in FIG. 1D.

FIGS. 2A and 2B show exemplary embodiments of the modular position sensor implemented as an LVDT sensor in accordance with aspects of the present invention.

FIG. 2C represents an exemplary illustration of a core member comprising a non-conducting rod on which is disposed ferromagnetic wedges in accordance with an embodiment of the present invention.

FIG. 2D represents a perspective view of the core member shown in FIG. 2B.

FIG. 2E illustrates an exemplary circuit diagram corresponding to the position sensor shown in FIG. 2B.

FIG. 3A shows an exemplary embodiment of a modular position sensor implemented as a variable reluctance sensor in accordance with the present invention.

FIG. 3B shows an exemplary circuit diagram corresponding to the position sensor shown in FIG. 3A.

FIG. 4 shows an exemplary embodiment of a modular position sensor according to another aspect of the present invention.

FIG. 5 shows an exemplary embodiment of a modular position sensor according to yet another aspect of the present invention.

FIG. 6 shows an alternative exemplary embodiment of a modular position sensor according to yet another aspect of the present invention.

### DETAILED DESCRIPTION

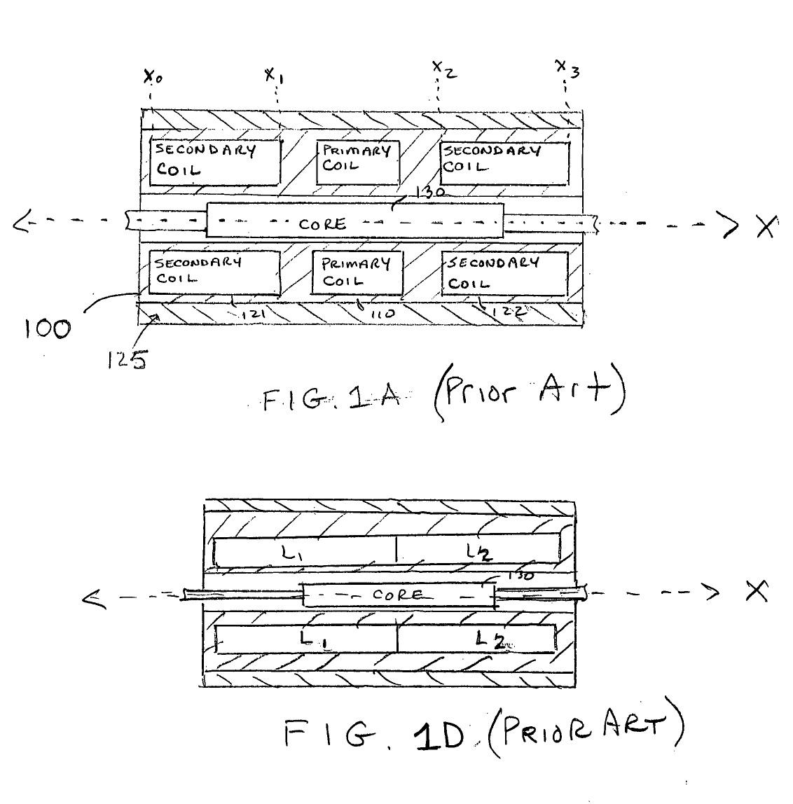

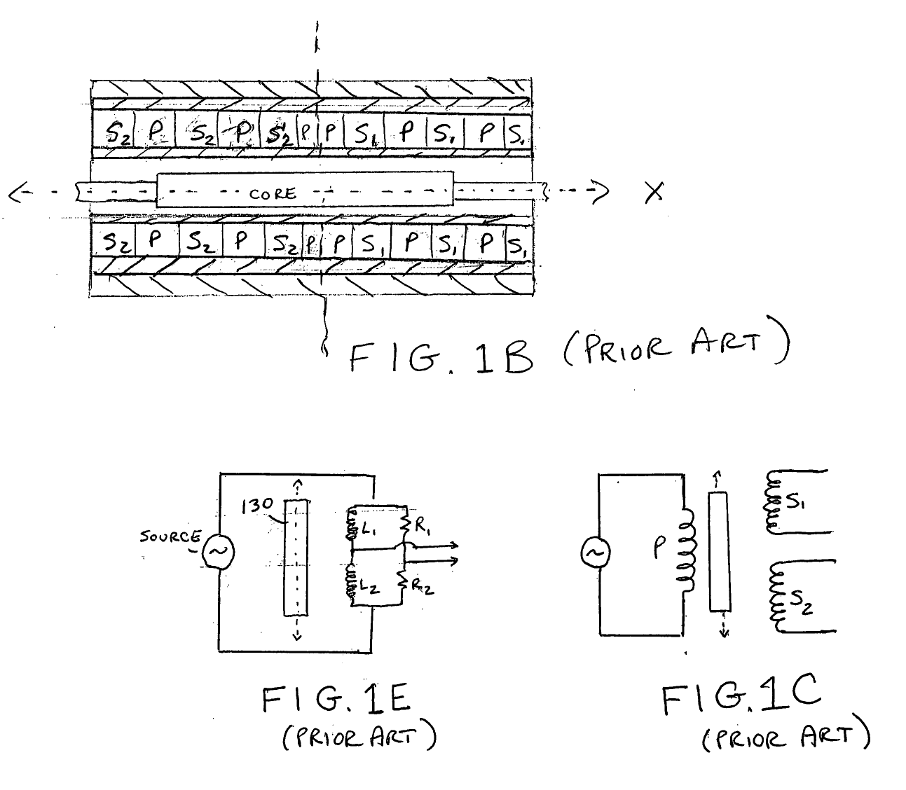

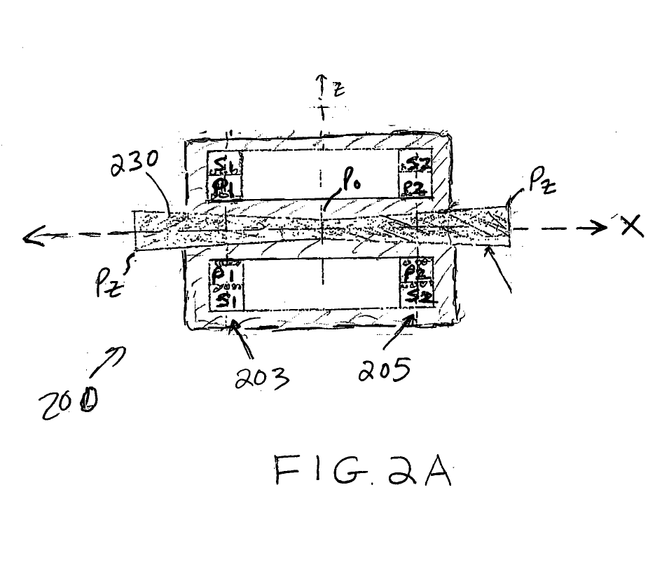

FIG. 1A (Prior Art) shows construction of a conventional 3 section LVDT useful for applications requiring relatively short strokes. As is well known, an LVDT is an electromechanical device that produces an electrical output proportional to the displacement of a separate moveable core. The coil assembly 100 consists of a primary coil 110 and two elongated secondary coils 121, 122 symmetrically spaced on a cylindrical form within a housing 125. An AC voltage signal (not shown) is applied to the primary coil to create an electromagnetic field. A rod-shaped, uniform diameter ferromagnetic core 130 inside the coil assembly is employed to couple the magnetic flux from the primary coil to the secondary coils. In this manner, when the primary coil is energized by an external AC source, voltages are induced in the secondary coils. The secondary coils are normally connected in series opposing one another such that the two secondary voltages are subtracted. Thus, the net output of the transducer is the difference between these two voltages, which is typically zero when the core is positioned at the center or null position (i.e. symmetry position). At the symmetry or null position, the core extends approximately half way into each secondary coil. Moving the core within the boundaries of the secondary coils increases the magnetic coupling in one secondary coil and decreases the coupling in the other. The electromagnetic field coupled to the secondary coils creates two complementary output voltages with the voltage of one secondary increasing while the voltage of the other secondary decreasing by the same value. Electronic circuitry (not shown) coupled to the secondary coils operates to process these signals in conventional fashion. The LVDT output signal is obtained by subtracting the two secondary output voltages. As previously mentioned, the output signal is zero when the core is at a central or null position (generally midway between the coils) and increases when the core moves away from the central position in either direction. The phase angle of the output signal reverses by 180 degrees from one side of the null point to the other.

In order to obtain a linear output signal as a function of position, the core movement should not only remain within the boundaries (i.e. between X0 and X1 and between X2 and X3) of the secondary coils but also stay clear of the magnetic fringe field areas around the edges of the secondary coils. As a result, the secondary coils must be designed to be relatively long since each secondary coil is required to be at least twice the specified linear travel distance of the LVDT core member, plus an additional length allowance for the inner and outer fringe areas around the coil edges. This means that the length of the secondary coils directly depends on the stroke length. Further, the secondary coils become longer as the required stroke length increases. For example, for a conventional 3 section LVDT having a stroke of about plus (+) or minus (−) 1 inch presently requires each secondary coil to be at least 2 inches long and, hence, requires the LVDT to be at least 5 inches in total length, resulting in a cumbersome and costly product.

FIG. 1B (Prior Art) shows a conventional long stroke LVDT assembly 100b which normally requires a coil form having a large number of bobbins in order to provide a more uniform primary magnetic field throughout the entire linear travel distance. As shown, each of the primary and first and second secondary coils around core 130 are represented as P, S1, and S2 respectively.

FIG. 1C (Prior Art) is a circuit diagram of the LVDT associated with FIGS. 1A and 1B.

FIG. 1D (Prior Art) is an illustration of a conventional variable reluctance (VR) position sensor comprising inductors L1, L2 around core 130, while FIG. 1E illustrates a circuit diagram corresponding to the position sensor shown in FIG. 1D.

Since the coil geometry of the conventional LVDT or VR position sensor changes depending upon its linear travel range, no commonality exists between sensors of different ranges. This prevents applying a modular, or building block approach, to the construction of LVDT and VR position sensors using conventional technology.

Herein is disclosed an apparatus and method of forming non-contact position sensors such as LVDT and VR position sensors using a building block modular approach. In the case of the modular LVDT, two standard relatively narrow coil assemblies replace the elongated secondary coils and a variable geometry core (e.g. ferromagnetic) replaces the conventional uniform diameter ferromagnetic core. The movement of the variable geometry ferromagnetic core, whose magnetic density varies along its longitudinal axis, inside the standard narrow coil assemblies provides substantially the same output signal as that generated by the movement of a uniform core inside of the long conventional coils, but without the added cost and size requirements of conventional devices. In similar fashion, the modular VR sensor operates on the same principle as discussed above.

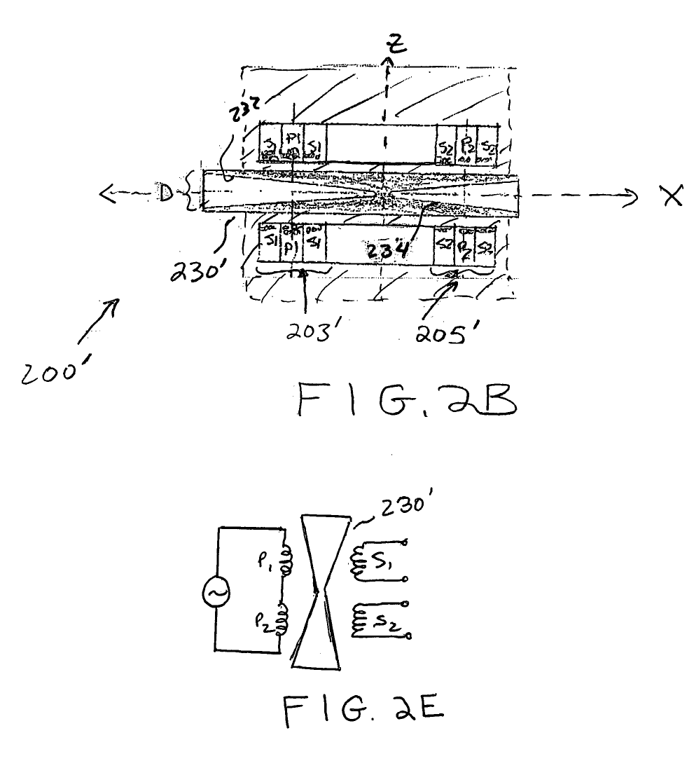

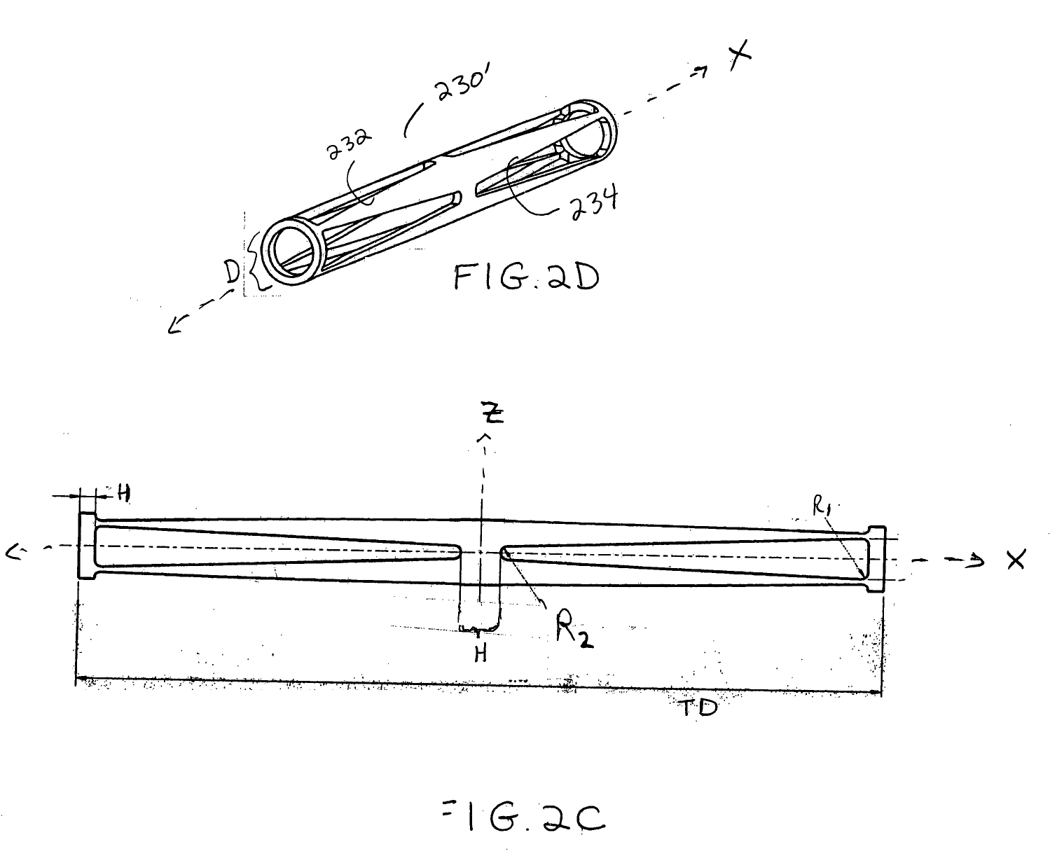

FIG. 2A shows an exemplary embodiment of a cross sectional view of a modular position sensor 200 comprising modular coil assemblies 203, 205 and a variable geometry core 230 disposed inside the coil assemblies according to an aspect of the present invention. Modular coil assembly 203 is formed of primary coil P1 having a predetermined number of windings and secondary coil S1 wound on top of coil P1 and having a predetermined number of windings. Modular coil assembly 205 has a primary coil P2 and secondary coil S2, identical to 203. Axial movement of the variable geometry core 230 inside the coil assemblies 203 and 205 (along x-axis) increases the magnetic field developed across the primary (e.g. P1) and its coupled flux to the secondary coil (e.g. S1) in one modular coil assembly (e.g. coil assembly 203), while reducing the magnetic field developed across the primary and its coupled flux to the secondary of the other modular coil assembly (e.g. coil assembly 205). In the exemplary embodiment of FIG. 2A, the variable geometry core 230 comprises a symmetrical dual tapered core whose magnetic density increases with increasing core diameter. In this embodiment, the linearly tapered cylindrical core has a minimum diameter about center position Po and increases to a maximum at end positions Pz. the dual tapered core operates to linearly vary the magnetic density of the core along its length. As is understood, each of the secondary coils responds to the position of the core member to generate an output signal indicative of the magnitude and direction of the core displacement. The output varies in a complimentary manner with one secondary increasing while the other is decreasing by the same amount. Conductors (not shown) coupled to the housing carry the output signals to control circuitry for processing. The control circuitry may either be co-located on the device or remote therefrom. That is, a position sensor such as an LVDT embodied in the present invention may include a separate signal conditioner processing module within a portion of the housing in electrical communication with the secondary coils to process the signals in order to provide an output indicative of the displacement of the core member. Alternatively, such signal conditioner processing electronics may be housed in a separate unit remote from the LVDT and connected thereto by a standard cable connection. As indicated in the drawing of FIG. 2A, for example, for LVDT operations, a primary coil is wound about a bobbin having a certain wall thickness and an opening into which a core member may be inserted. A secondary coil having a predetermined number of windings is wound on top of the primary coil as shown in FIG. 2A or side by side as shown in FIG. 2B. These coil assemblies may be identical, at least in terms of length, number of turns, wire size, internal spacing, diameter and the like, so that the coils can be standardized and mass produced for use independent of a desired stroke length. Core 230 is separated from the coil assemblies (e.g. by an air gap) such that no physical contact exists between the movable core and the coil assemblies within the housing. The only variables from one range to the other are the axial spacing or distance between the modular coil assemblies and the geometry of the core member. In this manner, the same modular coil assembly may be used for virtually all stroke lengths

FIG. 2B illustrates another embodiment of the present invention, wherein the variable geometry magnetic core comprises a slotted, tubular magnetic core 230′ having uniform diameter D but formed with slots or grooves 232, 234 within the magnetic core to change its magnetic density along its length. Such a “constant diameter” core advantageously reduces the sensitivity of the device to undesirable transverse motion. In the exemplary embodiment shown in FIG. 2B, the uniform diameter core 230′ comprises two sets of oppositely disposed, symmetrical, mirror image tapered grooves 232, 234 for varying the magnetic density of the core. As further shown in FIG. 2B, modular coil assemblies 203′ and 205′ each comprise a different arrangement of primary coil and two secondary coils in side by side configuration. FIG. 2C depicts another version of a constant diameter core comprising two sets of ferromagnetic tapered wedges 242, 244 disposed on a non-conductive, uniform diameter rod 240. Such wedges can be manufactured inexpensively by stamping or chemical fabrication techniques, for example. FIG. 2D depicts an alternative uniform diameter, slotted core arrangement. Unlike the core in conventional LVDTs, the variable geometry core stays fully inserted inside the coil assemblies throughout the entire stroke length. As is understood, the varying magnetic density increases the output of one secondary in one modular coil assembly and decreases output of the secondary in the other modular coil assembly.

From the above, one can see that position sensor units of different strokes lengths can use the same modular coil assembly to achieve the same results by changing only the length of the variable geometry core 230 and the spacing between the coil assemblies This provides the desired building block modular approach since the pair of standard modular coil assemblies, which lend themselves to mass production at low cost, replace the individually designed coil assemblies of conventional LVDT devices. Instead, the sensor component part, which varies from unit to unit, is the variable geometry core which is an easily manufactured component. As a result, the high cost of designing, manufacturing, winding, interconnecting and stocking a large variety of elaborate, multi-bobbin coil forms is replaced by the dramatically lower cost of forming and stocking different variable geometry (e.g. tapered, slotted or wedge based) cores of various lengths according to the desired stroke.

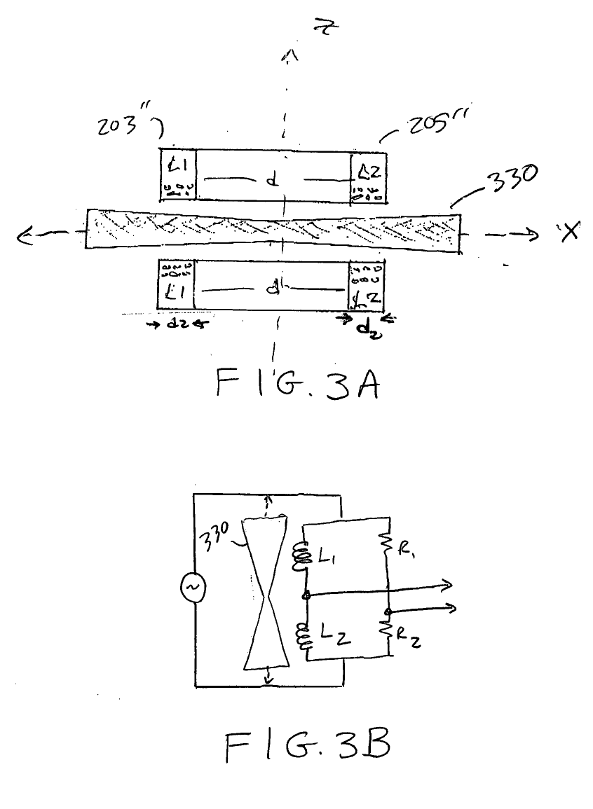

FIG. 3A is an exemplary embodiment of an application of the present invention to a variable reluctance (VR) position sensor 300 comprising a pair of modular single coil assemblies 203″, 205″ spaced apart from one another a predetermined distance d and a variable geometry core 330 such as the tapered, slotted or wedge based core members depicted in FIG. 2. In a preferred embodiment, the coil assemblies may be standard coils having a same predetermined number of windings and of same length d2. As shown in FIG. 3A, the inductance of the coils L1, L2 may be varied by movement of the variable geometry ferromagnetic core along its axis X. Such movement of the ferromagnetic core causes the coil inductance to change due to the increase or decrease in the core magnetic density. FIG. 3B illustrates a schematic circuit diagram associated with the structure of FIG. 3A.

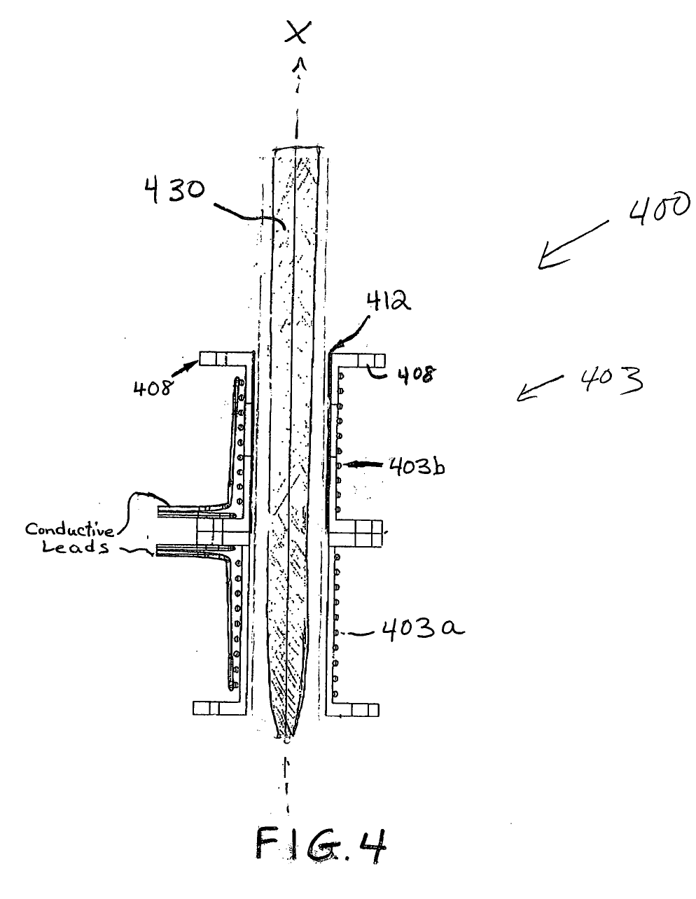

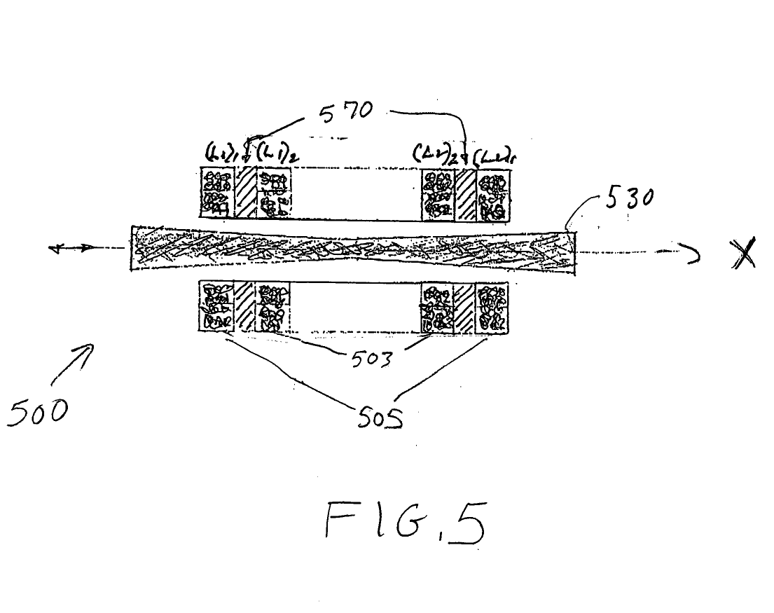

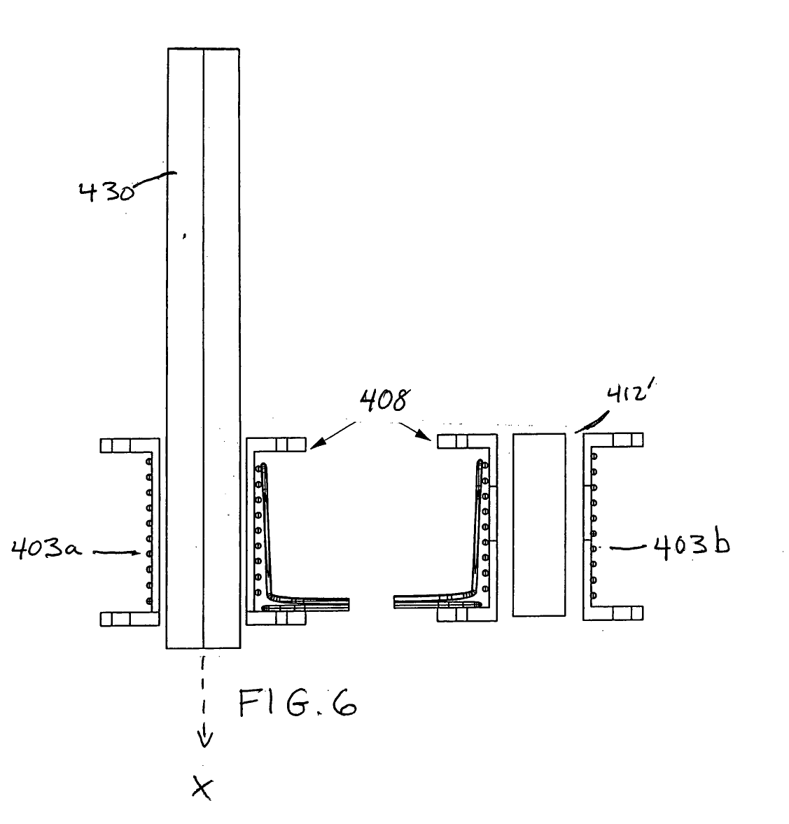

In an alternative embodiment, FIG. 4 shows a single coil assembly version of the modular approach. It requires a spoiler made of a conductive material that will cause the coil inductance to change as a result of the spoiler conduction density. This is the area of the conductive surface and its proximity. The spoiler approach employs Eddy current losses to manipulate inductance and may be suitable for AC operation at higher frequencies (e.g. 20 KHz and up). As shown in FIG. 4, a position sensor 400 comprises core member 430 disposed within an opening of the assembly and surrounded by a single coil assembly 403 comprising one active coil 403a and one inactive or fixed (i.e. pre spoiled) coil 403b. The coils are positioned adjacent one another as shown in FIG. 4. The pre-spoiled coil 403b is disposed about a non-conductive bobbin 408 in contact with conductive sleeve 412. Conductive sleeve 412 is preferably a thin layer of metal or other conductive material for pre-spoiling or predisposing coil 403b so that it is insensitive to the axial movement of core member 430. A variable geometry shaped core member 430 shaped in an elongated bullet-like fashion (in contrast to the previously discussed linearly tapered core members) is operative in conjunction with the active coil 403a and pre-spoiled coil 403b to compensate for non-linearities introduced by the arrangement of the active and pre-spoiled coils to obtain a linear output signal. This configuration advantageously provides a simple, compact and low cost implementation of a non-contacting coil based position sensor.

In accordance with another aspect of the present invention, FIG. 5 shows in schematic fashion a position sensor 500 employing a redundant dual channel sensor comprising two pairs of modular coil assemblies 503, 505 disposed a predetermined distance x from one another and operable in conjunction with a common variable geometry spoiler member 530 for generating an output signal indicative of the displacement of the spoiler member. The pairs of coil assemblies are shielded from one another by a protective shielding 570 in order to minimize interaction between channels. The configuration depicted in FIG. 5 advantageously reduces both the size and cost associated with the manufacture of such redundant position sensors. The building block modular approach, which is based upon narrow coil sensor assemblies, is ideally suited for designing redundant LVDTs.

Unlike conventional LVDT and VR position sensors, the novel method of forming is inherently modular since its construction is based upon standard building blocks. The same narrow coil subassemblies are used in sensors of all ranges. The difference between units of different ranges is in the spacing between the coils, the size and shape of the core and the size of the outer housing. The ability to construct LVDT and VR using coil subassemblies in the form of standard building blocks represents a major advance in the technology, providing greater design flexibility, simpler structures and smaller sizes, in addition to savings in manufacturing and inventories.

As shown and described herein, the novel modular narrow standardized coil subassemblies can be wound on bobbins. They can also lend themselves to manufacturing by multi-layer printed circuit technology using fine lines and spacing. It is contemplated that the use of automated batch processing manufacturing technique will yield even greater cost savings, potentially reducing costs by two orders of magnitude for large OEM applications.

It is to be understood that the embodiments and variations shown and described herein are for illustrations only and that various modifications may be implemented by those skilled in the art without departing from the scope of the invention. For example, while a ferromagnetic or conductive core material has been described, the invention also applies to other types of core materials, such as thermomagnetic materials. Furthermore, modular standard coil assembly sized may be formed having various deflection ranges, but they are most effective in mid and long range sensors from about one quarter to over ten inches. Further, the variable geometry cores may be manufactured using various mass production techniques, such as machined using numerically controlled machinery, stamping, chemical fabrication or conductive plating. All such variations are contemplated to be within the scope of the present invention as defined by the appended claims.

What is claimed is:

1. A method for forming a non-contact position sensor having a predetermined stroke length, said method comprising:
providing a pair of coil assemblies each comprising a primary and secondary coil of a predetermined size;
providing a core member of varying magnetic density about its length; and
inserting the core member within the coil assemblies, whereby axial movement of the core member relative to the coil assemblies causes a corresponding output signal from said coil assemblies indicative of the position of the core member.

2. The method of claim 1, wherein said core member of varying magnetic density about its length is made of a ferromagnetic material.

3. The method of claim 1, wherein the core member of varying magnetic density about its length is obtained by forming slots within portions of the core member.

4. The method of claim 1, wherein the core member of varying magnetic density about its length is obtained by tapering portions of the core member.

5. The method of claim 1, wherein each of the coil assemblies are substantially identical.

6. The method of claim 1, wherein the core member of varying magnetic density about its length is obtained by disposing tapered ferromagnetic wedges on a non-conducting rod.

7. The method of claim 1, wherein the core member of varying magnetic density about its length is obtained by forming a uniform diameter core member and forming slots within the core member while retaining the uniform diameter.

8. The method of claim 1, further comprising providing a bobbin on which the coil assembly is wound.

9. The method of claim 1, wherein the lateral spacing between coil assemblies is varied according to desired stroke length.

10. A non-contact position sensor having a predetermined stroke length comprising:
a core member; and
a pair of modular coil assemblies disposed about the core member, said pair of modular coil assemblies being of predetermined dimensions,
wherein the core member has a magnetic density that varies along its length such that axial movement of the core induces corresponding signals in said pair of modular coil assemblies indicative of the position of said core.

11. The sensor of claim 10, wherein the sensor is an LVDT.

12. The sensor of claim 10, wherein the sensor is a variable reluctance (VR) sensor.

13. The sensor of claim 10, wherein the core member comprises a dual tapered, symmetrically shaped ferromagnetic rod.

14. The sensor of claim 10, further comprising electronic circuitry coupled to the coil assembly for providing a differential output signal corresponding to the core position.

15. The sensor of claim 10, wherein one of said modular coil assemblies comprises a first spoiled coil insensitive to movement of said core member about said first coil; and the other of said modular coil assemblies comprises an active coil; and wherein the core member comprises an asymmetrical elongated conductive core having a tapered end portion.

16. A method of forming a non-contacting position sensor having a predetermined stroke length comprising:
providing a first standard coil of predetermined size;
providing a second standard coil of said predetermined size;
providing a core member;
pre-spoiling the first standard coil to be insensitive to movement of said core member about said first coil;
varying the magnetic density of said core member about its length in accordance with the predetermined stroke length and the size of the first and second standard coil assembly; and
inserting the core member within the first and second standard coils, whereby axial movement of the core member relative thereto causes a corresponding output signal from said first and second coils indicative of the position of the core member.

17. The method of claim 16, wherein the step of varying comprises tapering a portion of said core.

18. A method of forming non-contacting position sensors having a given stroke length using a coil assembly of a given length, comprising the steps of:
providing a core member;
varying the magnetic density of said core member about its length in accordance with the predetermined stroke length and the length of the coil assembly; and
inserting the core member within the coil assembly, whereby axial movement of the core member relative to the coil assembly causes a corresponding output signal from said coil assembly indicative of the position of the core member, wherein the coil assembly has a length less than twice the desired stroke length.
